(19) United States
(12) Patent Application Publication
(10) Pub. No.: US 2025/0315420 A1
(43) Pub. Date: Oct. 9, 2025

(54) METHOD FOR BUILDING DATABASE FOR RETRIEVAL-AUGMENTED GENERATION INTERLINKED WITH GENERATIVE ARTIFICIAL INTELLIGENCE AND APPARATUS THEREFOR

(71) Applicant: SAMSUNG SDS CO., LTD., Seoul (KR)

(72) Inventors: Woosun HAN, Seoul (KR); Seungmin BAEK, Seoul (KR); Tae Hwang YOO, Seoul (KR); Jookyung PARK, Seoul (KR); Yuseok JEONG, Seoul (KR)

(73) Assignee: SAMSUNG SDS CO., LTD., Seoul (KR)

(21) Appl. No.: 19/169,470

(22) Filed: Apr. 3, 2025

(30) Foreign Application Priority Data
Apr. 3, 2024 (KR) 10-2024-0045454
May 30, 2024 (KR) 10-2024-0071129

(51) Int. Cl. G06F 16/22; G06F 16/383

(52) U.S. Cl. CPC G06F 16/2237; G06F 16/383

(57) ABSTRACT

A method retrieval-augmented generation (RAG) interacting with generative AI method is provided. The method includes collecting data from a plurality of collaborative systems, and building a database to perform vector searching by embedding and indexing the data. The collecting of the data includes replicating a custom message queue to generate a replicated message queue based on a determination that a first collaborative system among the plurality of collaborative systems has the custom message queue, and collecting data from the replicated message queue instead of the custom message queue.

### CROSS-REFERENCE TO RELATED APPLICATION(S)

This application claims the benefit under 35 U.S.C. 119 of Korean Patent Application No. 10-2024-0045454 filed on Apr. 3, 2024, and Korean Patent Application No. 10-2024-0071129 filed on May 30, 2024, in the Korean Intellectual Property Office, the entire disclosures of which are herein incorporated by reference for all purposes.

### BACKGROUND

### 1. Field

The following description is intended to optimize the output of generative artificial intelligence (hereinafter “GenAI”) such as a large language model (hereinafter “LLM”), and improve the accuracy of its responses, and more specifically, the following description relates to a method for building a database for retrieval-augmented generation (hereinafter “RAG”) that interacts with generative AI, and an apparatus therefor.

### 2. Description of Related Art

Fine-adjusting the LLM itself using internal data held by companies to utilize GenAI generally requires a lot of resources and effort, and it is difficult to efficiently update the parameters of a model pre-trained based on a large amount of data.

Therefore, in order to alleviate the hallucination phenomenon of LLMs, a RAG method is widely used, in which the results of performing similarity search for queries by configuring a knowledge repository are added as context and input to LLMs to obtain answers highly relevant to a specific field.

In particular, companies have high demand for RAG that causes the LLM to answer based on information/knowledge inside the companies because the response of LLM related to a specific task inside a specific company can greatly contribute to improving the company's work expertise and efficiency.

To this end, an approach may be considered to simply embed and index fixed static information (work guides, FAQs, notices, manuals, etc.) inside the company to build a search database, then, based on this, perform a similarity search such as a vector search to obtain context, and provide the obtained context to the LLM so that the LLM can answer based on information/knowledge inside the company.

However, this approach has the limitation in which the LLM cannot be utilized based on various dynamic information (e.g., documents, mails, chats, meetings, etc.) that is frequently generated by numerous people in charge of work inside the company.

Typically, companies operate various collaborative systems (e.g., drives, mail, messenger, meeting, etc.) to assist employees with their work, so it is possible to cause the LLM to answer based on the work information inside the company through the RAG configuration of searching for work-related information of employees, which is frequently accumulated in the collaborative systems, and provide it, as a dynamic context, to the LLM. Data of the collaborative systems inside companies have a high degree of similarity and continuity for specific tasks inside the company, so searching for the same enables the retrieval/utilization of meaningful existing data, which is of great value for use in LLM-based RAG.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

In a general aspect, a retrieval-augmented generation (RAG) interacting with generative artificial intelligence (AI) method includes collecting data from a plurality of collaborative systems; and building a database to perform vector searching by embedding and indexing the received data, wherein the collecting of the data comprises: replicating a custom message queue to generate a replicated message queue based on a determination that a first collaborative system among the plurality of collaborative systems has the custom message queue; and collecting data from the replicated message queue instead of the custom message queue.

The collecting of the data may further include consuming an event generated in the first collaborative system from the replicated message queue; and enquiring metadata and content related to the event of the first collaborative system.

The consuming of the event further may further include filtering the event.

The collecting of the data may include collecting data through a batch server connected to a second collaborative system among the plurality of collaborative systems based on a determination that the second collaborative system does not have a custom message queue.

The collecting of the data may include synchronizing, based on an event received from the first collaborative system among the plurality of collaborative systems, metadata related to the event in the database with the first collaborative system.

The metadata may include authority information about content related to the event of the first collaborative system, and the event may include information about changes in the authority information.

The metadata may include status information of content related to the event of the first collaborative system, the event may include information about changes in the status information, and the status information may include information about deletion or changes of the content.

The collecting of the data may further include determining whether to synchronize the metadata, based on a frequency of occurrence of the event related to the metadata; and performing enquiry from the first collaborative system at a time at which a user accesses content information in the database for the retrieval-augmented generation based on a determination that the metadata is not synchronized.

In a general aspect, a retrieval-augmented generation (RAG) interacting with generative artificial intelligence (AI) method includes collecting data from a plurality of collaborative systems; transmitting the collected data through a plurality of separate queues; and building a database to perform vector searching by embedding and indexing the transmitted data, wherein the indexing comprises processing multiple pieces of data having a same identifier among the transmitted data in a same instance among multiple instances provided in an indexer.

The indexing may include sorting multiple pieces of data having the same identifier among the transmitted data during bulk indexing based on an order of an event occurrence time, and then sequentially indexing the multiple pieces of data.

The order of the event occurrence time may be ascending.

The method may further include comparing an event occurrence time based on a determination that data having the same identifier as indexing target data exists in an internal cache of the indexer, and, excluding the data from the indexing target based on a determination that the indexing target data has an earlier event occurrence time than the data having the same identifier in the internal cache.

The method may further include comparing an event occurrence time based on a determination that data having the same identifier as indexing target data exists in the database and, excluding the data from the indexing target based on a determination that the indexing target data has an earlier event occurrence time than the data having the same identifier in the database.

In a general aspect, an apparatus includes one or more processors; and a memory, wherein the memory stores instructions that, when executed by the one or more processors, cause the apparatus to implement specific operations for retrieval-augmented generation (RAG) interacting with generative artificial intelligence (AI), wherein the specific operations include collecting data from a plurality of collaborative systems; and building a database to perform vector searching by embedding and indexing the received data, and wherein the collecting of the data includes replicating the custom message queue to generate a replicated message queue based on a determination that a first collaborative system among the plurality of collaborative systems has a custom message queue; and collecting data from the replicated message queue instead of the custom message queue.

The collecting of the data may further include consuming an event generated in the first collaborative system from the replicated message queue; and enquiring metadata and content related to the event of the first collaborative system.

The consuming of the event may further include filtering the event.

The collecting of the data may include collecting data through a batch server connected to a second collaborative system among the plurality of collaborative systems based on a determination that the second collaborative system does not have a custom message queue.

The collecting of the data may include synchronizing, based on an event received from the first collaborative system among the plurality of collaborative systems, metadata related to the event in the database with the first collaborative system.

The metadata may include authority information about content related to the event of the first collaborative system, and the event may include information about changes in the authority information.

The metadata may include status information of content related to the event of the first collaborative system, the event may include information about changes in the status information, and the status information may include information about deletion or changes of the content.

Other features and aspects will be apparent from the following detailed description, the drawings, and the claims.

### BRIEF DESCRIPTION OF DRAWINGS

FIG. 1A and FIG. 1B are schematic diagrams illustrating the configuration of an LLM-linked RAG system interlinked with a collaborative system such as a messenger (or chat) system, a drive (or document management) system, and a mail system according to an embodiment of the disclosure. For convenience, the configuration of one embodiment is separately illustrated into FIG. 1A and FIG. 1B, and A, B, and C represent data paths connected to each other in both drawings.

FIG. 2 illustrates an example of mapping metadata of respective pieces of data having different content among collaborative systems 100, 200, and 300 in the form of an integrated index for integrated management in an LLM-linked RAG system.

FIG. 3A and FIG. 3B are diagrams illustrating (a) an example of synchronizing metadata such as authority information between a collaborative system and an LLM-linked RAG system and (b) an example of performing real-time query at the time of database query.

FIG. 4 is a diagram illustrating a process for preventing data inversion due to queue separation during indexing in an LLM-linked RAG system.

FIG. 5 illustrates an apparatus 120 to which the proposed method of the disclosure may be applied.

Throughout the drawings and the detailed description, unless otherwise described, the same reference numerals refer to the same elements. The drawings may not be to scale, and the relative size, proportions, and depiction of elements in the drawings may be exaggerated for clarity, illustration, and convenience.

### DETAILED DESCRIPTION

The following detailed description is provided to assist the reader in gaining a comprehensive understanding of the methods, apparatuses, and/or systems described herein. However, various changes, modifications, and equivalents of the methods, apparatuses, and/or systems described herein will be apparent after an understanding of the disclosure of this application. For example, the sequences within and/or of operations described herein are merely examples, and are not limited to those set forth herein, but may be changed as will be apparent after an understanding of the disclosure of this application, except for sequences within and/or of operations necessarily occurring in a certain order. As another example, the sequences of and/or within operations may be performed in parallel, except for at least a portion of sequences of and/or within operations necessarily occurring in an order, e.g., a certain order. Also, descriptions of features that are known after an understanding of the disclosure of this application may be omitted for increased clarity and conciseness.

Although terms such as “first,” “second,” and “third”, or A, B, (a), (b), and the like may be used herein to describe various members, components, regions, layers, or sections, these members, components, regions, layers, or sections are not to be limited by these terms. Each of these terminologies is not used to define an essence, order, or sequence of corresponding members, components, regions, layers, or sections, for example, but used merely to distinguish the corresponding members, components, regions, layers, or sections from other members, components, regions, layers, or sections. Thus, a first member, component, region, layer, or section referred to in the examples described herein may also be referred to as a second member, component, region, layer, or section without departing from the teachings of the examples.

Throughout the specification, when a component or element is described as “on,” “connected to,” “coupled to,” or “joined to” another component, element, or layer, it may be directly (e.g., in contact with the other component, element, or layer) “on,” “connected to,” “coupled to,” or “joined to” the other component element, or layer, or there may reasonably be one or more other components elements, or layers intervening therebetween. When a component or element is described as “directly on”, “directly connected to,” “directly coupled to,” or “directly joined to” another component element, or layer, there can be no other components, elements, or layers intervening therebetween. Likewise, expressions, for example, “between” and “immediately between” and “adjacent to” and “immediately adjacent to” may also be construed as described in the foregoing.

The terminology used herein is for describing various examples only and is not to be used to limit the disclosure. The articles “a,” “an,” and “the” are intended to include the plural forms as well, unless the context clearly indicates otherwise. As non-limiting examples, terms “comprise” or “comprises,” “include” or “includes,” and “have” or “has” specify the presence of stated features, numbers, operations, members, elements, and/or combinations thereof, but do not preclude the presence or addition of one or more other features, numbers, operations, members, elements, and/or combinations thereof, or the alternate presence of an alternative stated features, numbers, operations, members, elements, and/or combinations thereof. Additionally, while one embodiment may set forth such terms “comprise” or “comprises,” “include” or “includes,” and “have” or “has” specify the presence of stated features, numbers, operations, members, elements, and/or combinations thereof, other embodiments may exist where one or more of the stated features, numbers, operations, members, elements, and/or combinations thereof are not present.

As used herein, the term “and/or” includes any one and any combination of any two or more of the associated listed items. The phrases “at least one of A, B, and C”, “at least one of A, B, or C”, and the like are intended to have disjunctive meanings, and these phrases “at least one of A, B, and C”, “at least one of A, B, or C”, and the like also include examples where there may be one or more of each of A, B, and/or C (e.g., any combination of one or more of each of A, B, and C), unless the corresponding description and embodiment necessitates such listings (e.g., “at least one of A, B, and C”) to be interpreted to have a conjunctive meaning.

The features described herein may be embodied in different forms, and are not to be construed as being limited to the examples described herein. Rather, the examples described herein have been provided merely to illustrate some of the many possible ways of implementing the methods, apparatuses, and/or systems described herein that will be apparent after an understanding of the disclosure of this application. The use of the term “may” herein with respect to an example or embodiment (e.g., as to what an example or embodiment may include or implement) means that at least one example or embodiment exists where such a feature is included or implemented, while all examples are not limited thereto. The use of the terms “example” or “embodiment” herein have a same meaning (e.g., the phrasing “in one example” has a same meaning as “in one embodiment”, and “one or more examples” has a same meaning as “in one or more embodiments”).

One or more examples may smoothly collect and integrate a large amount of data produced by employees through various existing collaborative systems (drives, mail, messenger, meeting, etc.) inside the company and closely related to the work of the company while minimizing changes of the existing collaborative systems, thereby efficiently building a search database for LLM-linked RAG capable of performing semantic searching based on information/knowledge inside the company.

One or more examples may provide a search database building method for LLM-linked RAG that minimizes changes of the existing collaborative systems and minimizes interference, overload, and performance degradation of the existing collaborative systems by building a data collection environment suitable for each collaborative system depending on its configuration, and an apparatus therefor.

One or more examples may smoothly reflect dynamic data changes in each collaborative system, and in particular, to build a search database for LLM-linked RAG that dynamically reflects the data life cycle, authority system, etc. of each collaborative system, thereby resolving data security issues through efficient searches, authority management, data life cycle management, and the like.

One or more examples may establish an efficient resource management process and update processing process in updating and managing the search database for LLM-linked RAG.

One or more examples may smoothly collect and integrate a large amount of data produced by employees through various existing collaborative systems (drives, mail, messenger, meeting, etc.) inside the company and closely related to the work of the company while minimizing changes of the existing collaborative systems, thereby efficiently building a search database for LLM-linked RAG capable of performing semantic searching based on information/knowledge inside the company.

### Overview

In order to build an LLM-linked RAG based on information/knowledge inside the company on the basis of various collaborative systems (drives, mail, messenger, meeting, etc.) inside the company, a method of implementing a similarity search engine through data embedding and indexing in each collaborative solution (system) and transmitting a request for search from the central RAG solution (system) to each collaborative system, thereby reconstructing responses, may be preferentially considered.

However, this method requires the introduction or implementation of a search engine (e.g., Elastic Search, etc.) for vector searching in each collaborative system, which requires upgrading the search engine of the existing collaborative system or introducing new software, and brings about major changes in the configuration and resources of the existing collaborative system or affecting the processes of the respective existing collaborative systems.

Therefore, the one or more examples propose an approach that builds a separate search database for RAG in an LLM-linked RAG system separate from the collaborative systems and implements a similarity search engine based on it.

Accordingly, it is desirous to derive an efficient method by carefully considering a problem of difficulty in integrating data among the collaborative systems due to differences in the format/structure/event thereof, a problem of difficulty in performing integrating and searching under a single standard due to a difference in the authority system among the collaborative systems, and a problem of difficulty in tracking the life cycle and management criteria of the collaborative systems due to its differences.

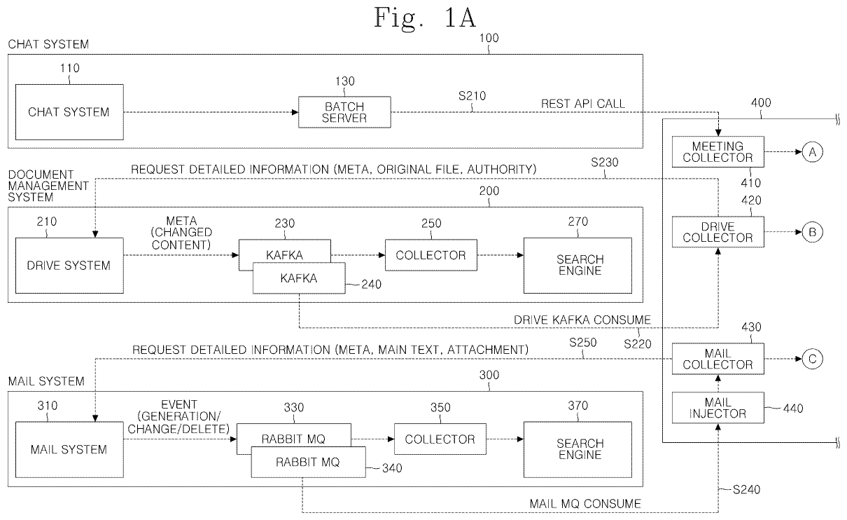

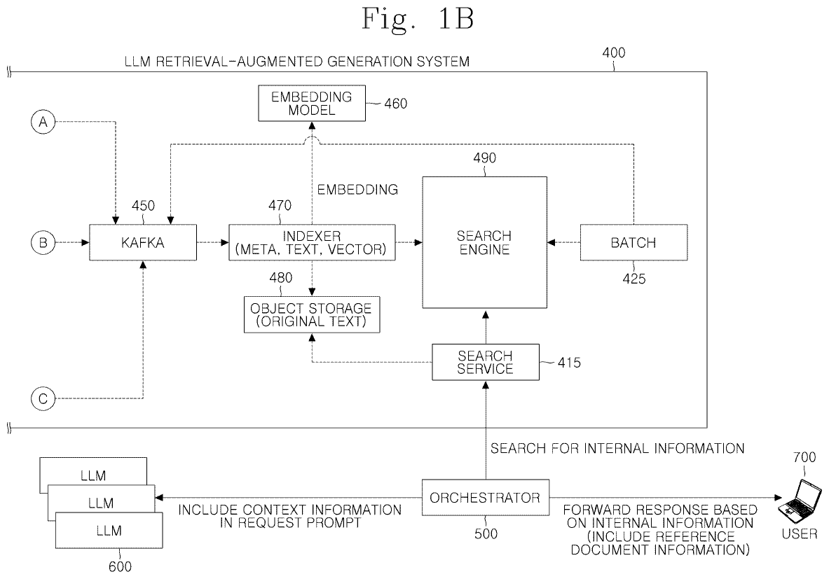

FIGS. 1A and 1B are schematic diagrams illustrating the configuration of an LLM-linked RAG system interlinked with a collaborative system such as a messenger (or chat) system, a drive (or document management) system, and a mail system according to an example embodiment of the disclosure. For convenience, the configuration of one embodiment is separately illustrated into FIG. 1A and FIG. 1B, and A, B, and C represent data paths connected to each other in both drawings.

Hereinafter, the configuration and operation of the embodiment will be described in detail with reference to FIG. 1A and FIG. 1B.

### Configuration of Collector for Each Collaborative System

In order to utilize LLMs by configuring a dynamic context based on various information (e.g., documents, mails, chats, meetings, etc.) generated frequently inside a company, a module or device for performing an operation of retrieving data from the collaborative systems 100, 200, and 300 in real time or near real time is desired in a RAG system 400.

In this example, there is a problem of difficulty in managing them in an integrated manner in the RAG system 400 because the format, structure, and event of the data processed by the collaborative systems 100, 200, and 300 are different from each other. To this end, collectors 410, 420, and 430 that collect data are respectively configured for the collaborative systems 100, 200, and 300, and the data is standardized and processed.

For example, in the example where message queues 230 and 330 for a search engine are respectively provided in the collaborative systems, such as a document management system 200 and a mail system 300 shown in FIG. 1A, in order to minimize the effect on the existing collaborative systems in the disclosure, separate replicated message queues 240 and 340 are configured for the RAG system 400 by replicating the existing message queues 230 and 330, instead of receiving data through the data transmission path of the existing message queues 230 and 330. Here, each message queue may be implemented using an event streaming platform such as Kafka or a message broker such as RabbitMQ, which is known.

The collectors 420 and 430 of the RAG system 400 interlinked with the replicated message queues 240 and 340 may configure an event consumer to consume events sent from each collaborative system and determine whether the event needs to be processed (S220 and S240). If it is determined that the event needs to be processed, primary detailed information related thereto may be queried from each collaborative system (S230 and S250).

Through this configuration, it is possible to minimize changes in the existing collaborative systems 200 and 300 or effects thereon.

Meanwhile, if there are many events that need to be processed due to a large amount of data generated in the collaborative system 300, a separate service module 440 may be provided to determine this. The service module 440 may implement filtering logic to filter events that need to be processed, and then a process may be performed in the service module 440 or the interlinked collector 430 to enquire the primary detailed information related thereto, such as metadata and files (or content), of the collaborative system 300 through, for example, a Rest API.

In addition, in the example of a collaborative system 100 (e.g., chat, conference, etc.) that does not have a separate search engine and thus does not have a message queue or generates continuous data in the form of a stream, a separate batch server 130 may be configured to periodically collect data and transmit it to the RAG system 400 (S210).

Through this configuration, it is possible to prevent the effects of error propagation, process changes, and the like, which may occur when the operations of the RAG system 400 are interlinked with various transactions for the unique business operations of the collaborative system 100.

Here, the collector 410 that collects data through the batch server 130 may be configured in the form of a Rest API.

As described above, data input from various collaborative systems 100, 200, and 300 is reconstructed into a single standardized message in the respective collectors 410, 420, and 430 and, as shown in FIG. 1B, is transmitted to an indexer 470 through a data platform (e.g., Kafka server) 450 and indexed in the search database of the search engine 490.

### Collection and Processing of Authority Information

The LLM-linked RAG system 400 of this embodiment may reflect dynamic data changes in each collaborative system 100, 200, or 300 and build a search database for LLM-linked RAG dynamically reflecting data life cycles, authorization systems, and the like of the respective collaborative systems 100, 200, and 300, thereby solving data security issues such as authorization management, data life cycle management, and the like, in addition to efficient search.

The collectors 410, 420, and 430 may send content or file data (e.g., mail body, text extracted from a file, chunks, etc.) and primary metadata (e.g., key values, status values, authority information, etc.), which are collected from the respective collaborative systems 100, 200, and 300 and are subject to similarity search of the search engine 490, to the indexer 470 for indexing.

When the collectors 410, 420, and 430 enquire primary metadata of the respective collaborative systems 100, 200, and 300, they collect authority information together. In order to reflect data security and dynamic data changes, it is desirable for the RAG system 400 to synchronize with the respective collaborative systems 100, 200, and 300 for changes in authority (addition, change, deletion, etc.) and changes in data status (deletion, change, etc.) regarding the content or file, and this is processed based on each event transmitted from each collaborative system.

For example, if authority regarding the content or file is granted based on a specific group in addition to an individual user or is frequently changed in the collaborative system so that the event processing and data management cost is too high (for example, if too much processing is required), in order to avoid system overload, a key value of the data accessible to the user may be enquired of the collaborative system in real time, instead of synchronizing the authority information, when the user terminal 700 requests a search from the RAG system 400, thereby retrieving the corresponding data through the search database, and may be processed.

In order to maintain data security, the search engine 490 may perform filtering based on the owner, authority, period, information status, and the like and restrict the scope of retrievable content, thereby performing a similarity search.

In order to implement this operation, items requiring real-time or immediate synchronization of metadata may be defined and priority may be assigned to them during synchronization so as to be processed separately (e.g., changing the sharing target, canceling sending mail, or the like).

In addition, it may be necessary to analyze the assignment system of user IDs, department IDs, group IDs, and the like for the respective collaborative systems 100, 200, and 300. For example, if the department ID values are different among the collaborative systems even in the same department, or if the department ID values are identically duplicated even among different departments, this may cause a problem in data integration in the RAG system 400, so in this example, data may be integrated by processing such as adding a separate prefix to the ID.

The primary authority information of the collaborative systems 100, 200, and 300 is stored in the database of the search engine 490 through the collectors 410, 420, and 430, the data platform 450, and the indexer 470. Since the content of the data differs among the collaborative systems 100, 200, and 300, it may be processed by mapping it as an integrated index during indexing by the indexer 470.

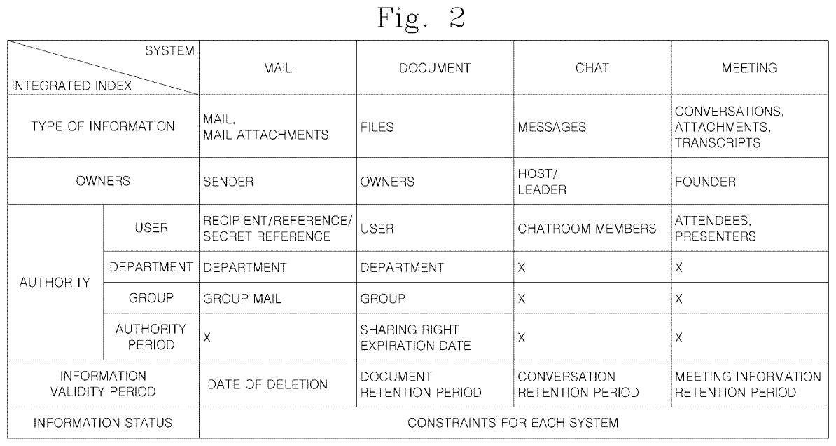

FIG. 2 illustrates an example of mapping metadata of respective pieces of data having different content among the collaborative systems 100, 200, and 300 in the form of an integrated index for integrated management in the LLM-linked RAG system 400.

Referring to, for example, the user item in FIG. 2, in the example of a document, although it is relatively clear that the user of the document corresponds to the user according to the nature of the data, the criteria are somewhat ambiguous in other examples, so the person listed in the items such as recipient, reference, and secret reference in the example of mail, the members of the chat room in the example of chat, and the attendees and hosts in the example of a meeting may be classified and indexed as metadata corresponding to the user item.

Similarly, for the information validity period item, the deletion date in the example of mail, the document retention period in the example of documents, the conversation retention period in the example of chat, and the meeting information retention period in the example of a meeting may be classified and indexed as metadata corresponding to the information validity period item.

As described above, since the content of metadata such as authority information differs among the collaborative systems 100, 200, and 300, the data may be managed as an integrated index in an abstracted form at a higher level, which is very efficient for the integrated management of the LLM-linked RAG system 400.

As illustrated in FIG. 2, the authority information items of the integrated index may define, for example, the owner, authority (user, group, and authority period), and information validity period, and items with related characteristics among the metadata received from the collaborative systems 100, 200, and 300 may be mapped as described above.

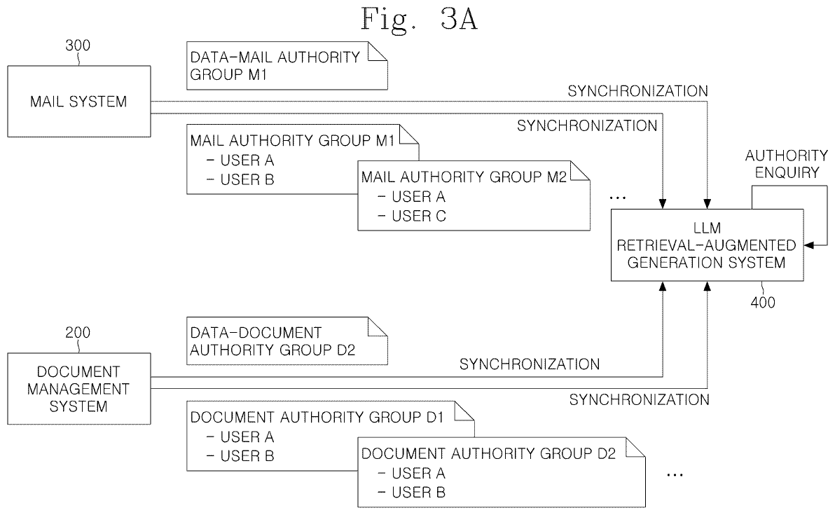

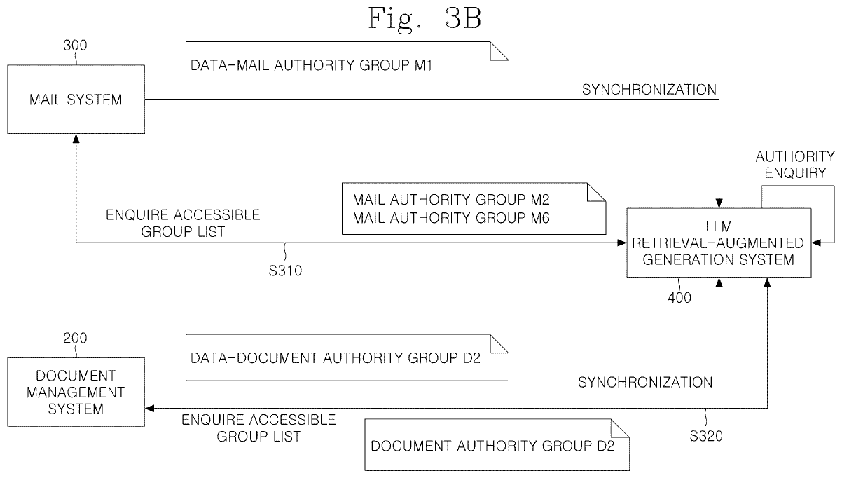

FIGS. 3A and 3B are diagrams illustrating (a) an example of synchronizing metadata such as authority information between the collaborative systems 100, 200, and 300 and the LLM-linked RAG system 400, and (b) an example of performing real-time query at the time of database query.

As illustrated in FIG. 3A, when metadata synchronization is performed, if the authority is assigned in units of groups or frequently changed in the collaborative system so that the event processing and group data management costs are too high, problems such as system overload and degradation of search speed may occur.

Therefore, in this example, as illustrated in FIG. 3B, a key value of the data to which the user 700 enquiring has authority to access may be enquired of the collaborative system in real time, instead of synchronizing the metadata, when the LLM-linked RAG system 400 searches for the corresponding data item from the search database built in the search engine 490 according to the search request of the user 700, and may be processed (operations S310 and S320). Information, such as the (retrievable) group ID to which the user belongs and the upper department ID, may be processed in the same manner.

In this configuration, there is no need to manage a storage for group data management or a separate synchronization logic, and there is an advantage in that the access authority of the user at the time of enquiring may be checked in real time.

### Processing Data Life Cycle-Related Events

As described above, data collected from the collaborative systems 100, 200, and 300 may be filtered and standardized by the respective collectors 410, 420, and 430 and indexed to the database of the search engine 490 by the indexer 470, and events may be received from the collaborative systems 100, 200, and 300 and synchronized to the search engine 490.

Here, a data platform 450 may be disposed between the collectors 410, 420, and 430 and the indexer 470. The data platform 450 may configure a message queue to loosely couple the data filtering and standardization process performed by the collectors 410, 420, and 430 and the indexing process performed by the indexer 470, thereby securing the durability of the system.

Accordingly, the data filtering and standardization operations of the collectors 410, 420, and 430 may be performed independently, regardless of the performance and operation of the indexer 470, and may respond to the increase and decrease of data from the collaborative systems 100, 200, and 300 through multiplexed configuration. The indexer 470 may also be multiplexed to conform to the amount of data to be indexed and the target performance, thereby obtaining the desired system performance.

In order to monitor examples where the database of the search engine 490 fails to reflect data changes, deletions, and the like in the collaborative systems 100, 200, and 300 due to a system failure or event data loss, the status may be periodically monitored through batches, thereby processing batch deletions.

As shown in FIG. 1A, data of the collaborative system 100 may be processed through a batch server 130 and Rest API (S210), or data of the collaborative systems 200 and 300 may be processed through replicated message queues 240 and 340 (operations S220 and S240). Preferably, all events sent from the collaborative systems 100, 200, and 300 may be tracked, and events related to the data life cycle, such as changes, deletions, and temporary deletions after data production, may be processed, thereby reflecting the same to the database of the search engine 490.

The data indexing operation performed by the indexer 470 may be performed by separately processing metadata (e.g., basic and authority information, etc.) and content data (e.g., mail body, file content, etc.) depending on the type of data and processing time. In this case, the metadata it may be indexed immediately due to a small amount of data, but the content data must be separately processed and may take more time to index because the amount of data is large, compared to the metadata. In order to prevent the indexing of metadata from being delayed due to a large amount of content data as described above, the queues may be separated and processed. Separating the queues indicates, for example, processing such as adding a topic if the data platform 450 is Kafka.

In the example where data collected from the multiple collectors 410, 420, and 430 is processed in bulk without distinction, if a large amount of data is input from a specific collector, the waiting for processing the data of the remaining collectors takes a long time. In addition, if the collector and the indexer are mapped one-to-one, when a large amount of data is input from a specific collector, the load is not evenly distributed to the indexer instances, so that a large load is applied to a specific instance, causing a problem in which the system resources cannot be used efficiently.

Therefore, it is possible to resolve the problems with a long waiting time and inefficient use of resources by grouping the instances of the indexer based on the data load and separating the queues, thereby applying similar loads to the respective instances of the indexer.

This queue separation may bring about data processing order problems, i.e. data inversion problems, such as pre-indexed data being overwritten by older data, so a method to prevent this is required.

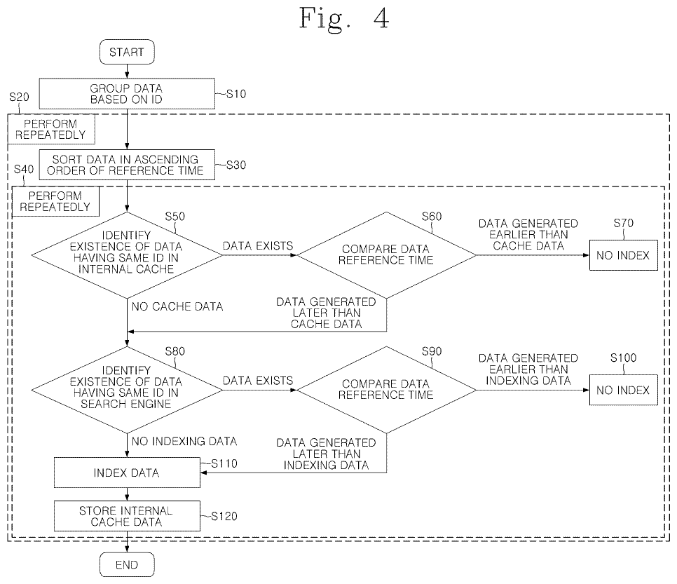

FIG. 4 is a diagram illustrating a process for preventing data inversion due to queue separation during indexing in an LLM-linked RAG system.

The collectors 410, 420, and 430 may transmit the collected data to the indexer 470 through multiple separated queues so as to embed and index the transmitted data, thereby building a database for performing vector searching.

Referring to FIG. 4, if the transmitted data includes multiple pieces of data with the same identifier ID (e.g., sending and deleting events for the same mail), the indexer 470 may group the data, based on the identifier ID, and process it in the same instance among multiple instances provided in the indexer 470 (operation S10).

In the example of bulk indexing, the indexer 470 may sort the multiple pieces of data with the same identifier ID among the transmitted data, based on the order of the event occurrence time (or data reference time such as mail sending time, file upload time, etc.) and then sequentially index the same (operation S30). Here, the order of the event occurrence time may be ascending.

If the data with the same identifier ID as the current indexing target data exists in the internal cache of the indexer 470 (operation S50), the indexer 470 may compare the event occurrence time (operation S60) and, if the current indexing target data has an earlier event occurrence time than the data with the same identifier ID in the internal cache, filter and exclude the data from the indexing target (operation S70), and proceed to the next step.

In addition, if the data with the same identifier ID as the current indexing target data exists in the search database of the search engine 490 (operation S80), the indexer 470 may compare the event occurrence times (operation S90) and, if the indexing target data has an earlier event occurrence time than the data with the same identifier ID in the database, exclude it from the indexing target (operation S100).

Through the above process, indexing may be performed on the data determined as the indexing target (operation S110), and the data may be stored in the internal cache, thereby preventing the problem of inversion of subsequent data (operation S120).

Apparatus to which Proposed Method of Disclosure is Applied

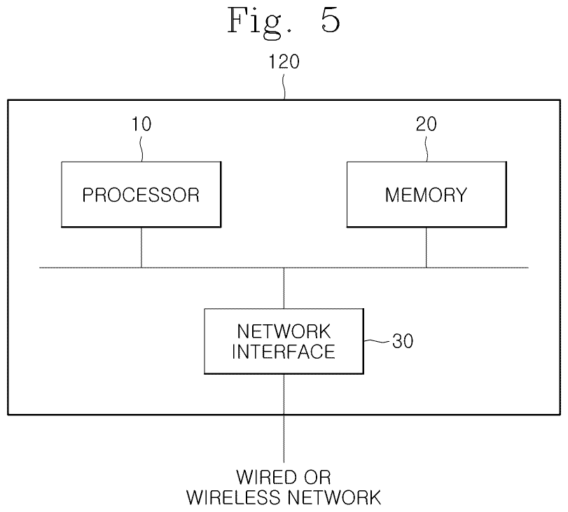

FIG. 5 illustrates an apparatus 120 to which the example embodiments may be applied.

Referring to FIG. 5, the apparatus 120 may be configured to implement a process according to a database building method for retrieval-augmented generation (RAG) interacting with the generative AI of the disclosure. For example, the apparatus 120 may be a server device or terminal device providing a RAG service.

For example, the apparatus 120 to which the one or more examples may be applied may include network devices such as repeaters, hubs, bridges, switches, routers, gateways, and the like, computer devices such as desktop computers, workstations, and the like, mobile terminals such as smartphones and the like, portable devices such as laptop computers and the like, home appliances such as digital TVs and the like, and moving means such as vehicles and the like. As another example, the apparatus 120 to which the one or more examples may be applied may be included as part of an ASIC (Application Specific Integrated Circuit) implemented in the form of an SoC (System-on-Chip).

The methods illustrated in FIGS. 1-5 that perform the operations described in this application are performed by computing hardware, for example, by one or more processors or computers, implemented as described above implementing instructions or software to perform the operations described in this application that are performed by the methods. For example, a single operation or two or more operations may be performed by a single processor, or two or more processors, or a processor and a controller. One or more operations may be performed by one or more processors, or a processor and a controller, and one or more other operations may be performed by one or more other processors, or another processor and another controller. One or more processors, or a processor and a controller, may perform a single operation, or two or more operations.

Instructions or software to control computing hardware, for example, one or more processors or computers, to implement the hardware components and perform the methods as described above may be written as computer programs, code segments, instructions or any combination thereof, for individually or collectively instructing or configuring the one or more processors or computers to operate as a machine or special-purpose computer to perform the operations that are performed by the hardware components and the methods as described above. In one example, the instructions or software include machine code that is directly executed by the one or more processors or computers, such as machine code produced by a compiler. In another example, the instructions or software includes higher-level code that is executed by the one or more processors or computer using an interpreter. The instructions or software may be written using any programming language based on the block diagrams and the flow charts illustrated in the drawings and the corresponding descriptions herein, which disclose algorithms for performing the operations that are performed by the hardware components and the methods as described above.

The instructions or software to control computing hardware, for example, one or more processors or computers, to implement the hardware components and perform the methods as described above, and any associated data, data files, and data structures, may be recorded, stored, or fixed in or on one or more non-transitory computer-readable storage media. Examples of a non-transitory computer-readable storage medium (for example, memory 20) include read-only memory (ROM), random-access programmable read only memory (PROM), electrically erasable programmable read-only memory (EEPROM), random-access memory (RAM), dynamic random access memory (DRAM), static random access memory (SRAM), flash memory, non-volatile memory, CD-ROMs, CD-Rs, CD+Rs, CD-RWs, CD+RWs, DVD-ROMs, DVD-Rs, DVD+Rs, DVD-RWs, DVD+RWs, DVD-RAMs, BD-ROMs, BD-Rs, BD-R LTHs, BD-REs, blue-ray or optical disk storage, hard disk drive (HDD), solid state drive (SSD), flash memory, a card type memory such as a multimedia card or a micro card (for example, secure digital (SD) or extreme digital (XD)), magnetic tapes, floppy disks, magneto-optical data storage devices, optical data storage devices, hard disks, solid-state disks, and any other device that is configured to store the instructions or software and any associated data, data files, and data structures in a non-transitory manner and provide the instructions or software and any associated data, data files, and data structures to one or more processors or computers so that the one or more processors or computers can execute the instructions. In one example, the instructions or software and any associated data, data files, and data structures are distributed over network-coupled computer systems so that the instructions and software and any associated data, data files, and data structures are stored, accessed, and executed in a distributed fashion by the one or more processors or computers.

The memory 20 may be connected to the processor 10 during operation, and may store programs, code, and/or instructions for processing and controlling the processor 10, and may store data and information used in the disclosure, control information required for processing data and information according to the disclosure, and temporary data generated during the data and information processing process.

The processor 10 may be operatively connected to the memory 20 and/or the network interface 30, and may control the operation of respective modules in the apparatus 120. In particular, the processor 10 may perform various control functions for performing the proposed method of the disclosure. The processor 10 may also be called a controller, a micro-controller, a micro-processor, a micro-computer, or the like. The proposed method of the disclosure may be implemented by hardware, firmware, software, or a combination thereof. When implementing the disclosure using hardware, an ASIC (application specific integrated circuit) or a DSP (digital signal processor), a DSPD (digital signal processing device), a PLD (programmable logic device), an FPGA (field programmable gate array), or the like, configured to perform the disclosure, may be provided in the processor 10. Meanwhile, when implementing the proposed method of the disclosure using firmware or software, the firmware or software may include instructions related to modules, procedures, or functions that perform functions or operations necessary for implementing the proposed method of the disclosure, and the instructions may be stored in the memory 20 or stored in a computer-readable recording medium (not shown) separate from the memory 20, and may be configured to cause, when executed by the processor 10, the apparatus 120 to perform the proposed method of the disclosure.

In addition, the apparatus 120 may include a network interface device 30. The network interface device 30 may be connected to the processor 10 during operation, and the processor 10 may control the network interface device 30 to transmit or receive wireless/wired signals carrying information, data, signals, and/or messages through a wireless/wired network. The network interface device 30 may support various communication standards such as IEEE 802 series, 3GPP LTE(-A), 3GPP 5G, etc., and may transmit and receive control information and/or data signals according to the corresponding communication standards. The network interface device 30 may be implemented outside the apparatus 120 as needed.

While this disclosure includes specific examples, it will be apparent after an understanding of the disclosure of this application that various changes in form and details may be made in these examples without departing from the spirit and scope of the claims and their equivalents. The examples described herein are to be considered in a descriptive sense only, and not for purposes of limitation. Descriptions of features or aspects in each example are to be considered as being applicable to similar features or aspects in other examples. Suitable results may be achieved if the described techniques are performed in a different order, and/or if components in a described system, architecture, device, or circuit are combined in a different manner, and/or replaced or supplemented by other components or their equivalents.

Therefore, in addition to the above and all drawing disclosures, the scope of the disclosure is also inclusive of the claims and their equivalents, i.e., all variations within the scope of the claims and their equivalents are to be construed as being included in the disclosure.

### INDUSTRIAL APPLICABILITY

The disclosure may be applied to various devices such as server devices, terminal devices, and network devices for building a database for retrieval-augmented generation (RAG) that interacts with generative AI.

What is claimed is:

1. A retrieval-augmented generation (RAG) interacting with generative artificial intelligence (AI) method, the method comprising:
collecting data from a plurality of collaborative systems; and
building a database to perform vector searching by embedding and indexing the received data,
wherein the collecting of the data comprises:
replicating a custom message queue to generate a replicated message queue based on a determination that a first collaborative system among the plurality of collaborative systems has the custom message queue; and
collecting data from the replicated message queue instead of the custom message queue.

2. The method of claim 1,
wherein the collecting of the data further comprises:
consuming an event generated in the first collaborative system from the replicated message queue; and
enquiring metadata and content related to the event of the first collaborative system.

3. The method of claim 2, wherein the consuming of the event further comprises filtering the event.

4. The method of claim 1,
wherein the collecting of the data comprises collecting data through a batch server connected to a second collaborative system among the plurality of collaborative systems based on a determination that the second collaborative system does not have a custom message queue.

5. The method of claim 1, wherein the collecting of the data comprises synchronizing, based on an event received from the first collaborative system among the plurality of collaborative systems, metadata related to the event in the database with the first collaborative system.

6. The method of claim 5,
wherein the metadata comprises authority information about content related to the event of the first collaborative system, and
wherein the event comprises information about changes in the authority information.

7. The method of claim 5,
wherein the metadata comprises status information of content related to the event of the first collaborative system,
wherein the event comprises information about changes in the status information, and
wherein the status information comprises information about deletion or changes of the content.

8. The method of claim 5,
wherein the collecting of the data further comprises:
determining whether to synchronize the metadata, based on a frequency of occurrence of the event related to the metadata; and
performing enquiry from the first collaborative system at a time at which a user accesses content information in the database for the retrieval-augmented generation based on a determination that the metadata is not synchronized.

9. A retrieval-augmented generation (RAG) interacting with generative artificial intelligence (AI) method, the method comprising:
collecting data from a plurality of collaborative systems;
transmitting the collected data through a plurality of separate queues; and
building a database to perform vector searching by embedding and indexing the transmitted data,
wherein the indexing comprises processing multiple pieces of data having a same identifier among the transmitted data in a same instance among multiple instances provided in an indexer.

10. The method of claim 9,
wherein the indexing comprises sorting multiple pieces of data having the same identifier among the transmitted data during bulk indexing based on an order of an event occurrence time, and then sequentially indexing the multiple pieces of data.

11. The method of claim 10, wherein the order of the event occurrence time is ascending.

12. The method of claim 9,
further comprising comparing an event occurrence time based on a determination that data having the same identifier as indexing target data exists in an internal cache of the indexer, and, excluding the data from the indexing target based on a determination that the indexing target data has an earlier event occurrence time than the data having the same identifier in the internal cache.

13. The method of claim 9,
further comprising comparing an event occurrence time based on a determination that data having the same identifier as indexing target data exists in the database and, excluding the data from the indexing target based on a determination that the indexing target data has an earlier event occurrence time than the data having the same identifier in the database.

14. An apparatus, comprising:
one or more processors; and
a memory,
wherein the memory stores instructions that, when executed by the one or more processors, cause the apparatus to implement specific operations for retrieval-augmented generation (RAG) interacting with generative artificial intelligence (AI),
wherein the specific operations comprise:
collecting data from a plurality of collaborative systems; and
building a database to perform vector searching by embedding and indexing the received data, and
wherein the collecting of the data comprises:
replicating the custom message queue to generate a replicated message queue based on a determination that a first collaborative system among the plurality of collaborative systems has a custom message queue; and
collecting data from the replicated message queue instead of the custom message queue.

15. The apparatus of claim 14,
wherein the collecting of the data further comprises:
consuming an event generated in the first collaborative system from the replicated message queue; and
enquiring metadata and content related to the event of the first collaborative system.

16. The apparatus of claim 15, wherein the consuming of the event further comprises filtering the event.

17. The apparatus of claim 14,
wherein the collecting of the data comprises collecting data through a batch server connected to a second collaborative system among the plurality of collaborative systems based on a determination that the second collaborative system does not have a custom message queue.

18. The apparatus of claim 14, wherein the collecting of the data comprises synchronizing, based on an event received from the first collaborative system among the plurality of collaborative systems, metadata related to the event in the database with the first collaborative system.

19. The apparatus of claim 18,
wherein the metadata comprises authority information about content related to the event of the first collaborative system, and
wherein the event comprises information about changes in the authority information.

20. The apparatus of claim 18,
wherein the metadata comprises status information of content related to the event of the first collaborative system,
wherein the event comprises information about changes in the status information, and
wherein the status information comprises information about deletion or changes of the content.
